(19) United States
(12) Patent Application Publication
(10) Pub. No.: US 2014/0000024 A1
(43) Pub. Date: Jan. 2, 2014

(54) APPARATUS AND METHOD FOR MOVING A DISABLE PERSON FROM A LYING POSITION ON A BED TO A SITTING POSITION

(71) Applicant: Marko Johannes Gerardus Van Loef, Eindhoven (NL)

(72) Inventor: Marko Johannes Gerardus Van Loef, Eindhoven (NL)

(21) Appl. No.: 14/017,601

(22) Filed: Sep. 4, 2013

Related U.S. Application Data
(63) Continuation of application No. PCT/NL2012/050135, filed on Mar. 5, 2012.

(30) Foreign Application Priority Data
Mar. 4, 2011 (NL) 2006342
Mar. 17, 2011 (NL) 2006417
Apr. 19, 2011 (NL) 2006624
Sep. 6, 2011 (NL) 2007364

(51) Int. Cl. A61G 7/10

(52) U.S. Cl. CPC A61G 7/10
USPC 5/83.1

(57) ABSTRACT

A method for moving a disabled person from a sitting position on the edge of a bed to a lying position, includes the steps of inserting a cross bar of the appliance behind the upper legs while the person is sitting upright. Then the disabled person takes hold of the ends of the cross bar after which the cross bar is pushed up at a bow and the upper body is moved backwards at a bow while the person tilts on his or her bottom until his or her feet are at a higher level than the top of the mattress of the bed. Then the person is turned for about a quarter of a turn until his or her legs have come above the bed.

### CROSS-REFERENCE TO RELATED APPLICATIONS

This application for a utility patent is a continuation of a previously filed patent application, now abandoned, having the application number PCT/NL2012/050135, filed Mar. 5, 2012.

This application also claims the benefit of the following Netherlands National applications: NL2006342, filed Mar. 4, 2011; NL2006417, filed Mar. 17, 2011; NL2006624, filed Apr. 19, 2011; and NL2007364, filed Sep. 6, 2011.

### BACKGROUND OF THE INVENTION

1. Field of the Invention

The invention relates to a method for moving a disabled person from a lying position on a bed to a sitting position and vice versa by means of an appliance, as well as an appliance suitable for this. Getting into and out of bed is difficult for disabled persons such as the elderly or patients in hospitals or care homes. Even with the assistance of a caregiver or a nurse, getting into bed and out of it is still trying and moreover burdensome to both the disabled person and the caregiver or nurse.

2. State of the Art

An appliance for getting into and out of bed is generally known. The known appliance is formed by a bar that is bent at a number of places, which bar can partly be brought underneath a disabled person's body and has at one end a handle with which the person can be turned and put up straight.

### SUMMARY OF THE INVENTION

It is an object of the invention to provide a method of the type defined in the opening paragraph with which a caregiver or nurse can help a disabled person in a simpler manner and with less physical effort than with the known appliance when helping the patient in getting into and out of bed. With respect to the method for a person to get out of bed the invention is characterized in that while the person is in a lying position, the legs are pulled up first and a first section of the appliance is inserted into the popliteal regions of the knees or behind the upper legs, after which a connection is made between the first section and the person's upper body after which the person is brought to an upright sitting position by pushing the knees and/or the first section of the appliance down at a bow and/or pushing the upper body up at a bow while the person pivots on his or her bottom, and in that the person while he or she is being sat upright or after he or she has been put on the bed in an upright position, is moved roughly a quarter of a turn until at any rate the lower legs protrude from the bed. Moving a person in this way requires less effort because the person's weight is of assistance by means of leverage when a person is sat upright on a bed.

An embodiment of the method according to the invention is characterized in that the connection between the first section of the appliance and the upper body is made in that the person takes hold of ends of the first section that protrude on either side of the knees with both hands or takes hold of the first section in the middle between the two legs. For this embodiment a very simple appliance will do.

Another embodiment of the method according to the invention is characterized in that the connection between the first section of the appliance and the upper body is made by introducing a loop around the upper body of the disabled person and connecting this loop to the first section of the appliance. As a result, the person himself or herself need not make any effort.

A further embodiment of the method according to the invention is characterized in that when the first section of the appliance is inserted into the popliteal regions of the knees or behind the upper legs, a support element of the appliance connected to the first section via a rigid connecting element is placed on the bed.

A still further embodiment of the method according to the invention is characterized in that the appliance further includes a second section which, when the first section is inserted into the popliteal regions of the knees or behind the upper legs, is present alongside or underneath the person's body, and in that the connection between the first section of the appliance and the upper body is made by securing the first and second sections relative to each other, or by securing the person's body relative to the second section of the appliance and/or securing the person's upper legs relative to the first section. The appliance may in this case be understood to be a chair without legs and arm rests, where the seat and the back are or are not hingeably connected to each other.

Yet a further embodiment of the method according to the invention is characterized in that the appliance further includes a long handle which is rigidly connected to the first section or can be telescoped out of the connecting element or can be coupled to the connecting element and which extends with one end to above the knees while the end is pushed down and/or pulled down at a bow when the person is being sat up straight into a sitting position and the end of the connecting element present on the bed is turned around an imaginary horizontal axis. In conjunction with the connecting element the long handle functions as a lever so that a person can be sat up straight with even less power.

With respect to the method for a person to step into bed, the invention is characterized in that while the person is sitting upright a first section of the appliance is inserted into the popliteal regions of the knees or behind the upper legs, after which a connection is made between the first section and the person's upper body, after which the knees and/or the first section of the appliance are pushed up at a bow and/or the upper body is allowed to recline at a bow during which action the person pivots on his or her bottom until the feet are at a higher level than the top side of the mattress of the bed, after which the person is moved roughly by a quarter turn until the legs are above the bed and then the knees and/or the first section of the appliance are pushed up further at a bow and/or the upper body is allowed to recline at a bow until the person rests on his or her back on the bed. This method is in essence the reverse of the method described above.

An embodiment of this method according to the invention is characterized in that the connection between the first section of the appliance and the upper body is made in that with both hands the person takes hold of the ends of the first section that extend on either side of the knees or takes hold of the first section in the middle between the two legs.

Another embodiment of this method according to the invention is characterized in that the connection between the first section of the appliance and the upper body is made in that a loop is introduced around the person's upper body and this loop is connected to the first section of the appliance.

A further embodiment of this method according to the invention is characterized in that before the person is placed on the edge of the bed, a support element connected to the first section of the appliance is laid on the bed after which the person is placed onto the support element.

Yet a further embodiment of this method according to the invention is characterized in that the appliance further includes a second section which is present behind or alongside the person's upper body and is rigidly or hingeably connected to the first section and can be secured relative to the first section. The appliance may again be arranged as a chair without legs and arm rests.

Still a further embodiment of this method according to the invention is characterized in that the appliance further includes a long handle which is rigidly connected to the first section or can be telescoped out of the connecting element or can be coupled to the connecting element and which extends with one end to above the knees, where the end is moved up at a bow when the disabled person is allowed to recline and the end of the connecting element present on the bed is turned around an imaginary horizontal axis. Again the long handle functions as a lever.

With respect to the appliance the invention is characterized in that the appliance comprises a first section which is formed by a longitudinal cross bar having a handle at either end and the distance between the two handles is between 30 and 80 cm, preferably approximately 60 cm. The handles may then form a whole with the cross bar or be connected to the cross bar by means of cords.

During use of the appliance for the disabled person to get into and out of bed the first section of the appliance is inserted into the popliteal regions of the knees or behind the upper legs of the disabled person. Subsequently, the first section is lifted while the knees of the disabled person bend. The disabled person then tilts forwards or backwards on his or her bottom while the person holds the first section in a firm grip. For those disabled persons who do not have sufficient strength to keep the first section in a firm grip, an embodiment of the appliance is characterized in that the cross bar is provided with first coupling means and the appliance further includes a loop that is provided with second coupling means which can be coupled to the first coupling means.

A further embodiment of the appliance according to the invention is characterized in that the appliance further includes a support element which is connected to the cross bar by means of a connecting element. The connecting element may be formed by a plurality of telescoping tubes which can be secured relative to each other for adjusting the appliance to the size of the disabled person who is to be assisted.

Yet a still further embodiment of the appliance according to the invention is characterized in that the appliance further includes a slide sheet to which the support element is attached, which slide sheet is placed underneath or around the legs of the person to be moved. During use the slide sheet is placed underneath or around the legs of the person to be moved. When helping a person in getting out of bed, this person can be turned more easily on the slide sheet once he has been supported to an upright position. To achieve this, the slide sheet is wrapped around both legs and held at the end. By pulling at the end of the slide sheet the person can be turned with his or her legs outside the bed. For getting a better grip on the slide sheet, a loop at or near an end is preferably attached to either side of the slide sheet.

Another embodiment of the appliance according to the invention is characterized in that the appliance comprises a first section which is inserted in a person's popliteal regions of the knees or behind a person's upper legs, as well as a second section which is introduced underneath his or her body and which is hingeably connected to the first section and can be secured relative to the first section. The appliance may then again be arranged as a chair without legs and arm rests.

A further embodiment of the appliance according to the invention is characterized in that the appliance further includes a long handle which is rigidly connected to the first section or can be telescoped out of the connecting element or can be coupled to the connecting element. During use this long handle functions as a lever so that it will need less effort to move the cross bar up and down.

### BRIEF DESCRIPTION OF THE DRAWINGS

Hereinbelow the invention will be further explained with reference to the embodiments of the appliance and its use shown in the appended drawings, in which:

FIG. 1 shows a top view of a first embodiment of the appliance according to the invention;

FIG. 2 shows a side view of the appliance shown in FIG. 1;

FIG. 3 shows a detail of the appliance in the place of adjusting means;

FIGS. 4 to 9 show various steps when assisting a disabled person at getting out of a bed;

FIGS. 10 to 14 show various steps when helping a disabled in getting into bed;

FIG. 15 shows a second embodiment of the appliance according to the invention in retracted state;

FIG. 16 shows the appliance shown in FIG. 15 in extended state;

FIGS. 17 and 18 show various views of a third embodiment of the appliance according to the invention represented during use.

### DESCRIPTION OF THE INVENTION

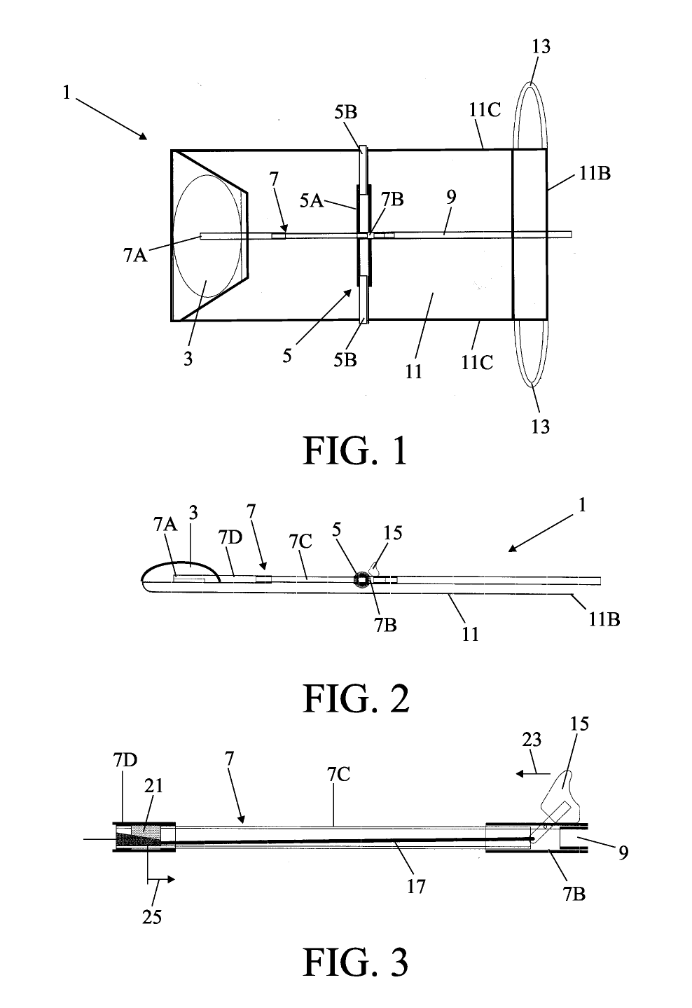

FIGS. 1 and 2 show an embodiment of the appliance according to the invention in top view and side view respectively. The appliance 1 comprises a support element 3 as well as a first section that is formed by a cross bar 5, and a connecting element 7 which is connected with one end 7A to the support element and with the other end 7B is affixed to the middle of the cross bar 5. This end 7B of the connecting element accommodates a long handle 9. The support element 3 is formed by a flexible plate.

The appliance 1 further includes a slide sheet 11 to which the support element 3 is fixed. At an end 11B of the slide sheet a loop 13 is affixed on either side 11C.

The cross bar 5 comprises a middle tube 5A and two side tubes 5B telescoping in it so that the cross bar 5 has an adjustable length. The connecting element 7 comprises an inner tube 7C and an outer tube 7D in which the inner tube can be telescoped for adjusting the length of the connecting element in a stepless way. The connecting element 7 accommodates a blocking mechanism by which the inner tube and outer tube can be secured relative to each other. This blocking mechanism is shown in FIG. 3 and has an operation button 15 which is connected via an operation bar 17 to a displaceable wedge 19 that cooperates with a beveled block 21 fixed to the inside of the outer tube 7D. By moving the operation button 15 to the left (arrow 23) the wedge 19 is pulled to the right by the operating rod 17 (arrow 25) and is clamped tight between the inner wall of the inner tube 7C and the block 21, as a result of which the inner tube 7C and outer tube 7D are secured relative to each other.

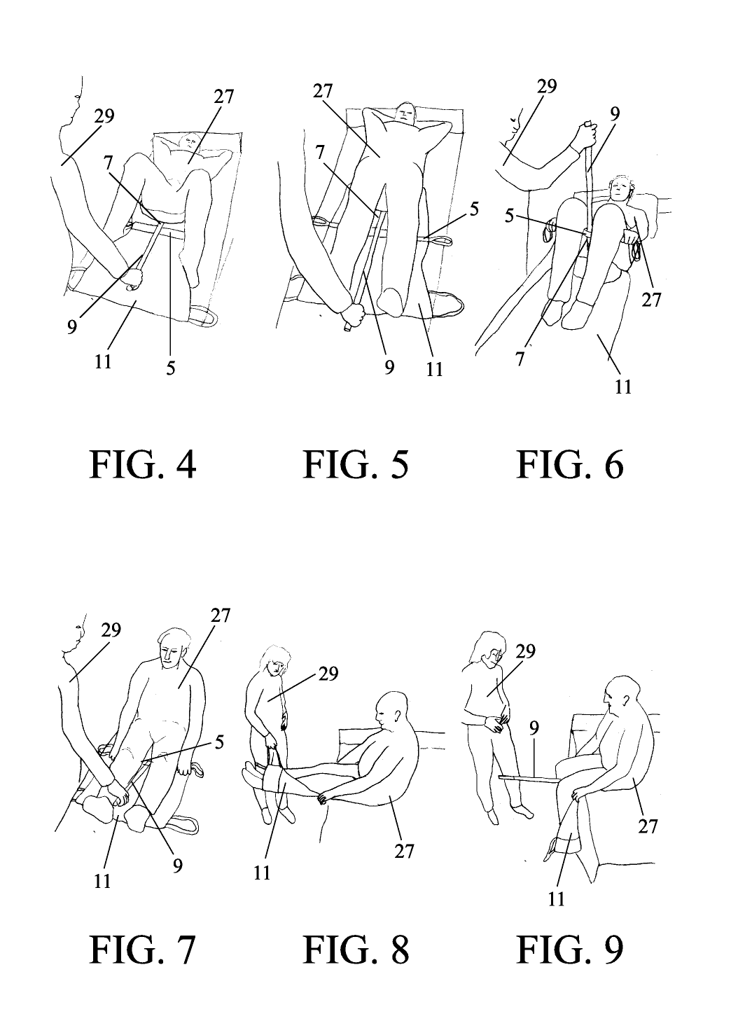

FIGS. 4 to 9 show the various steps when helping a disabled person in getting out of a bed. First of all the support element 3 is slid underneath the bottom of the disabled person 27 (FIG. 4) and the cross bar 5 is inserted under the popliteal regions of the knees of the disabled person (FIG. 5). So doing, the disabled person 27 ends up with his or her legs on the slide sheet 11. Then the cross bar 5 with the long handle 9 is raised by a caregiver 29 (FIG. 6) while the disabled patient's knees are bending. The connecting element 7 then tilts over the end by which it is connected to the support element 3. Then the disabled person 27 should take hold of the ends of the cross bar 5 with his hands.

Then the caregiver 29 lowers the cross bar 5 by pushing the long handle 9 down (FIG. 7) while the disabled person 27 keeps hold of the cross bar 5. The connecting element 7 again tilts around an imaginary horizontal axis at the end of the connecting element 7 by which it is connected to the support element 3. Since the disabled person 27 keeps hold of the cross bar 5 he or she is brought into an upright position. Finally, the caregiver 29 turns the disabled person 27 by putting the slide sheet 11 around the legs and by pulling at the loops 13 until the legs protrude from the bed (FIG. 8). Then the disabled person 27 can stand up (FIG. 9).

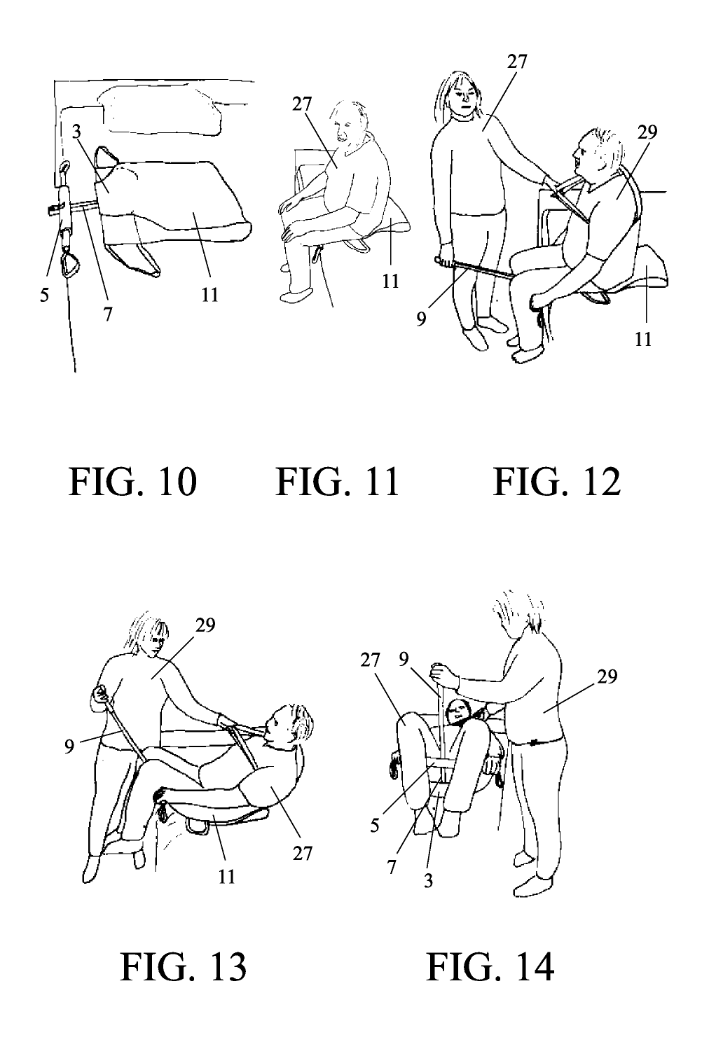

FIGS. 10 to 14 show the various steps when helping a disabled person in getting into a bed. The appliance is laid transversely on the bed with the crossbar 5 parallel to the edge of the bed (FIG. 10). Then the disabled person 27 sits himself on the support element 3 with the popliteal regions of the knees or the upper legs near the popliteal regions of the knees on the cross bar (FIG. 11). Then the disabled person takes hold of the ends of the cross bar 5 and the caregiver 29 links the long handle 9 to the connecting element 7 (FIG. 12). Then the cross bar 5 is raised by the caregiver 29 (FIG. 13), while the disabled person 27 tilts backwards until his or her back rests on the bed. Finally, the person 27 is turned until he or she lies on the bed lengthways (FIG. 14).

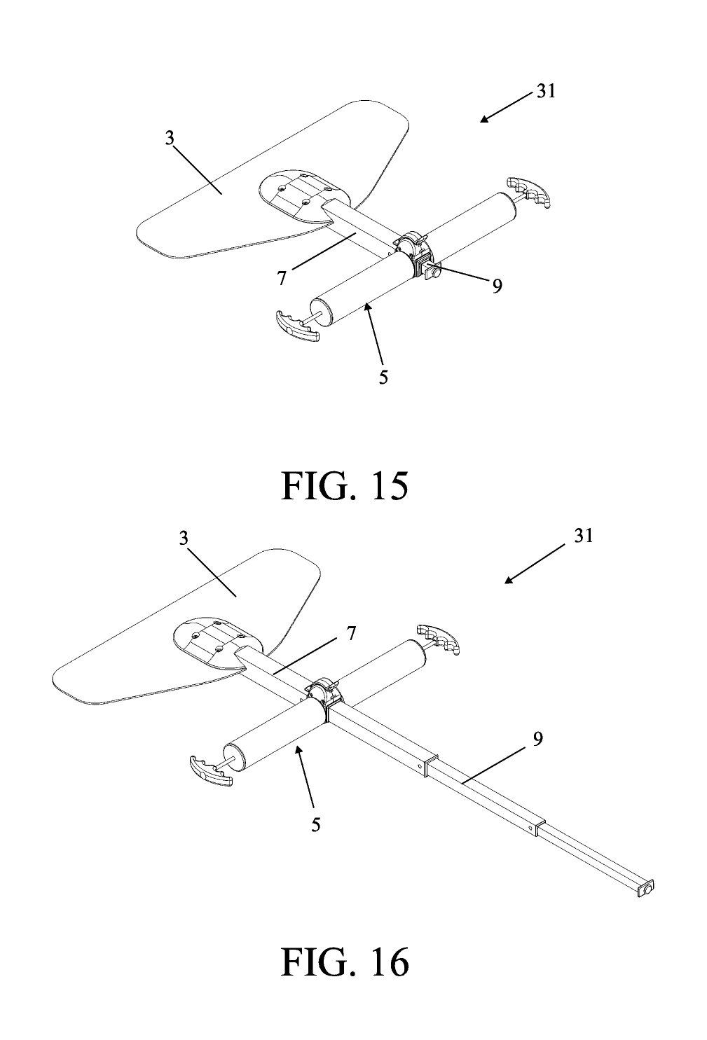

FIGS. 15 and 16 show a second embodiment of the appliance according to the invention in retracted state and extended state respectively. All components similar to those of the first embodiment are referred to by like reference numerals. In this embodiment the appliance 31 does not have a slide sheet and the handles are configured as eyelets which are connected to the first section by means of cords. Also in this appliance 31 the long handle 9 comprises a plurality of telescopic tubes.

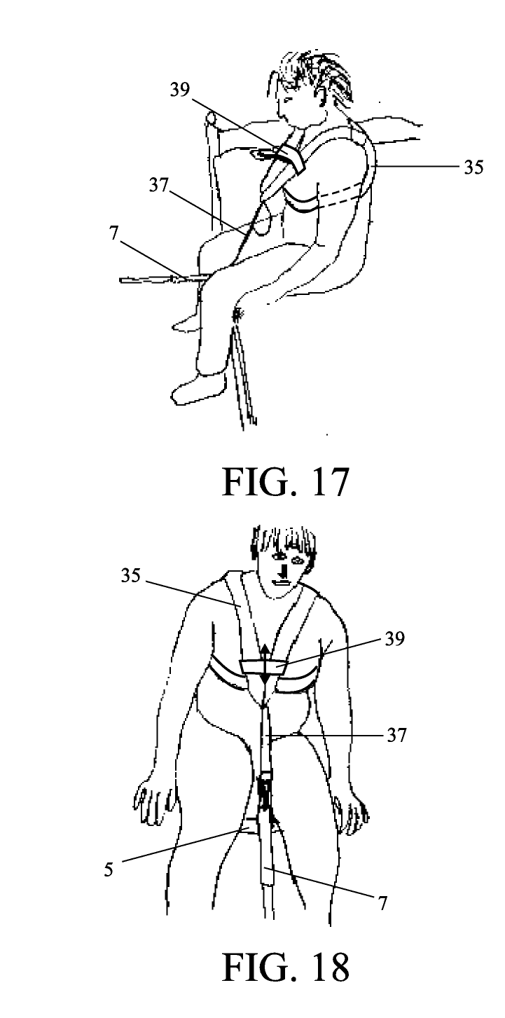

FIGS. 17 and 18 show various views of a third embodiment of the appliance according to the invention during use. This appliance comprises a loop-shaped band 35 that is wrapped around the disabled person's body and is connected via first coupling means 37 to the first section 5 or the connecting element 7. This embodiment is advantageous to disabled persons who do not have sufficient strength for keeping a firm grip on the first section.

The band 35 is introduced around the chest while the part that would be positioned on the back is pulled over the person's head. In this way the band 35 runs from the chest under the arm pits and over the shoulders to the front. At the front the band is connected via the first coupling means 37 to the middle of the first section 5 or to the connecting element 7 near the first section.

Two parts of the loop-shaped band 35 are running down from the shoulders and a ring-shaped band 39 surrounds these bands so that the loop around the disabled person can be made smaller or larger by moving the ring-shaped band up and down respectively.

Albeit the invention has been described in the foregoing with reference to the drawings, it should be pointed out that the invention is not by any manner or means restricted to the embodiments shown in the drawings. The invention also extends over any embodiments deviating from the embodiments shown in the drawing Figures within the spirit and scope defined by the claims. For example, the appliance may also be arranged as a chair without legs and arm rests, where the seat and the back are or are not hingeably connected to each other and can be secured relative to each other.

I claim:

1. A method for moving a disabled person from a lying position on a bed to a sitting position by means of an appliance, the method comprising the steps of:
pulling up the legs of the user while the person is in a lying position;
inserting a first section of the appliance into the popliteal regions of the knees or behind the upper legs;
connecting the first section and the person's upper body;
pushing the knees and/or the first section of the appliance down at a bow and/or pushing the upper body up at a bow while the person tilts on his or her bottom, thereby lifting the person to an upright sitting position; and
moving the person roughly a quarter of a turn until the lower legs protrude from the bed.

2. The method of claim 1, wherein the connection between the first section of the appliance and the upper body is made in that with both hands the person takes hold of ends of the first section that protrude on either side of the knees or takes hold of the first section in the middle between the two legs.

3. The method of claim 1, wherein the connection between the first section of the appliance and the upper body is made by introducing a loop around the person's upper body and connecting this loop to the first section of the appliance.

4. The method of claim 1, wherein when the first section of the appliance is inserted into the popliteal regions of the knees or behind the upper legs, a support element of the appliance connected to the first section via a connecting element is placed on the bed.

5. The method of claim 1, wherein the appliance further includes a second section which, when the first section is inserted into the popliteal regions of the knees or behind the upper legs, is present alongside or underneath the person's body, and in that the connection between the first section of the appliance and the upper body is made by securing the first and second sections relative to each other, or by securing the person's body relative to the second section of the appliance and/or securing the person's upper legs relative to the first section.

6. The method of claim 4, wherein the appliance further includes a long handle which is rigidly connected to the first section or can be telescoped out of the connecting element or can be coupled to the connecting element and which extends with one end to above the knees, where the end is pushed down at a bow and/or pulled down at a bow when the person is being sat up straight into a sitting position and the end of the connecting element present on the bed is turned around an imaginary horizontal axis.

7. A method for moving a disabled person from a sitting position on the edge of a bed to a lying position by means of an appliance, wherein while the person is sitting upright a first section of the appliance is inserted into the popliteal regions of the knees or behind the upper legs, after which a connection is made between the first section and the person's upper body, after which the knees and/or the first section of the appliance are pushed up at a bow and/or the upper body is allowed to recline at a bow during which action the person tilts on his or her bottom until the feet are at a higher level than the top side of the mattress of the bed, after which the person is moved roughly by a quarter turn until the legs are above the bed and then the knees and/or the first section of the appliance are pushed up at a bow and/or the upper body is allowed to recline at a bow until the person lies on his or her back on the bed.

8. The method of claim 7, wherein the connection between the first section (5) of the appliance (1; 31) and the upper body is made in that with both hands the person takes hold of the ends of the first section that extend on either side of the knees or takes hold of the first section in the middle between the two legs.

9. The method of claim 7, wherein the connection between the first section of the appliance and the upper body is made by putting a loop around the upper body of the disabled person and connecting this loop to the first section of the appliance.

10. The method of claim 7, wherein before the person is placed on the edge of the bed, a support element of the appliance connected to the first section of the appliance is laid on the bed after which the person is placed onto the support element.

11. The method of claim 7, wherein the appliance further includes a second section which is present behind or alongside the person's upper body and is rigidly or hingeably connected to the first section and can be secured relative to the first section.

12. The method of claim 10, wherein the appliance further includes a long handle which is rigidly connected to the first section or can be telescoped out of the connecting element or can be coupled to the connecting element and which extends with one end to above the knees while the end is pushed up at a bow when the person is allowed to recline while the end of the connecting element present on the bed is turned around an imaginary horizontal axis.
